(19) United States
(12) Patent Application Publication
(10) Pub. No.: US 2024/0359748 A1
(43) Pub. Date: Oct. 31, 2024

(54) Hole Closure Element for a Body Component, and Body Component Equipped Therewith

(71) Applicant: Bayerische Motoren Werke Aktiengesellschaft, München (DE)

(72) Inventors: Niklas SCHAPER, Muenchen (DE); Julian SCZEPANSKI, Muenchen (DE); Philipp STROBL, Absberg (DE)

(21) Appl. No.: 18/553,423

(22) PCT Filed: Mar. 7, 2022
(86) PCT No.: PCT/EP2022/055725

§ 371 Date: Sep. 29, 2023

(30) Foreign Application Priority Data
Apr. 1, 2021 (DE) 10 2021 108 450.4

(51) Int. Cl. B62D 25/24

(52) U.S. Cl. CPC B62D 25/24

(57) ABSTRACT

A hole closure element for an opening located in a body component includes a carrier element made of a film material and an adhesive located on one side of the carrier element. The adhesive does not require thermal activation and covers a first surface region of the carrier element. The adhesive does not cover a second surface region of the carrier element and the second surface region not covered by the adhesive protrudes from a virtual plane formed by the carrier element and is configured to be received by the opening.

### BACKGROUND AND SUMMARY

The present invention relates to a hole closure element for a body component and to a body component equipped therewith.

Car bodies of motor vehicles have a multitude of openings, or holes, that are to be closed permanently as part of the production process. For this purpose, hole closure elements are inserted into the openings of body components, as is known from DE 10 2018 208 732 A1. Such a known hole closure element for an opening in a body component comprises a carrier element made of a film material, and an adhesive on one side of the carrier element. Thus, the known hole closure element is realized as a substantially flat surface, for the precise mounting of which a positioning aid, in the form of a marking, is provided on the body component.

It is an object of the present invention to specify an alternative to the known hole closure elements.

The hole closure element according to the invention for an opening located in a body component has a carrier element made of a film material and has an adhesive located on one side of the carrier element. The carrier element may be made of any suitable carrier material, in particular a plastic, such as in particular polyethylene terephthalate (PET), polyurethane (PU), polypropylene (PP) or polyvinyl chloride (PVC), or of a metal, or metal alloy, such as in particular aluminum or an aluminum alloy. The adhesive is realized as an adhesive that does not require thermal activation and that covers only one surface region of the carrier element, while at least one further surface region of the carrier element is not covered by the adhesive, i.e., is adhesive-free. In other words, the hole closure element has an adhesive portion and a non-adhesive, or adhesive-free, portion. The surface region not covered by the adhesive, i.e., the non-adhesive portion, protrudes from a virtual plane formed by the carrier element and is designed to be received by the opening. When the hole closure element according to the invention is being fitted, the portion projecting from the carrier element guides the hole closure element like a positioning means, or centering means, in such a way that the non-adhesive portion of the hole closure element projects into the opening, while the adhesive portion comes to bear on the body component surrounding the opening and is reliably and advantageously fastened to it by means of adhesive or material bond without heat treatment.

Overall, it is advantageously possible to position the hole closure element without any further markings on the hole closure element itself and/or on the body component, such that it is not necessary to provide an additional installation space for these markings or to perform an additional manufacturing step for applying them. Furthermore, the required installation time for the hole closure elements is reduced, as they can be applied to the body component manually or mechanically with a greater tolerance, but one that is sufficient for reliable bonding. Finally, the fastening of the hole closure element is effected without the additional step of heat treatment, which advantageously simplifies and speeds up the attaching of the hole closure element. The advantages mentioned are all the more important because the hole closure elements according to the invention can be used in large numbers for mass-produced body components.

According to a preferred embodiment, the surface region not covered by the adhesive is realized as at least one thickening of the film material and is designed to be received in the opening. This makes it possible, advantageously, for the hole closure element to be made from only two different materials, namely a material for the surface material of the carrier element integrally comprising the thickening of material, and a material, different from the latter, for the adhesive. The thickening of material may in particular be provided as a doubling of the carrier material or as a material elevation of the carrier material at the point that is to be received in the opening.

Alternatively or cumulatively, it is possible for the surface region not covered by the adhesive to be realized as at least one protrusion of the film material and to be designed to be received in the opening. The protrusion may in particular be realized as an embossment of the carrier element, of a specific region or of a plurality of specific regions of the entire hole closure element in the direction of the part to be received in the opening. Again, the hole closure element is composed of only two different materials, namely a material for the surface material of the carrier element integrally comprising the protrusion, and a material, different from the latter, for the adhesive. Unlike the previously disclosed realization of the carrier element with thickening of material, the carrier element having a protrusion has substantially no build-up of material, such that it is comparatively lighter and more flexible, materials being otherwise the same.

Irrespective of how the portion of the carrier material to be inserted into the opening is realized on or with the hole closure element, it may be provided according to a preferred configuration that the surface region not covered by the adhesive, or adhesive-free, has a peripheral taper at its end that is most distant from the adhesive. This may be realized in particular as a chamfer, a bevel or a rounding. This facilitates the insertion of the portion of the hole closure element according to the invention that is intended for positioning in the opening, making it easier overall to attach the hole closure element according to the invention.

In principle, the surface region not covered by the adhesive and the surface region covered by the adhesive may be located at any suitable position on the hole closure element, provided that proper attaching and fastening is possible. According to a preferred embodiment, the surface region not covered by the adhesive is located in the center of the hole closure element, and the surface region covered by the adhesive is located outside of the center of the hole closure element. Advantageously, this makes it possible, in particular, for even non-circular openings to be closed easily and reliably.

It is understood that the hole closure element according to the invention may in particular have a circular surface from which the surface region not covered by the adhesive protrudes, in particular orthogonally. To facilitate the insertion of this protruding region and to create a particularly good bond, it is provided according to a preferred embodiment that the surface region not covered by the adhesive has a first surface magnitude A1, and the surface region covered by the adhesive has a second surface magnitude A2, wherein the following relationship applies between the first surface magnitude Al and the second surface magnitude A2:

$$1 / 4 \cdot A 2 \leq A 1 \leq 1 / 3 \cdot A 2$$

In other words, the surface magnitude of the part of the hole closure element according to the invention that is covered by the adhesive is substantially two to three times as great as the surface magnitude of the portion of the hole closure element according to the invention that is not covered by the adhesive.

As previously disclosed, the adhesive required to securely bond the hole closure element to a body component is realized as an adhesive that does not require thermal activation. According to a preferred embodiment, the adhesive is realized as a pressure-sensitive adhesive, in a particularly preferred manner as an acrylic adhesive. This makes it possible to provide a multiplicity of ready-to-use hole closure elements according to the invention in arcuate form or in the form of adhesive tapes, which advantageously further facilitates and speeds up mounting of the hole closure elements on a, in particular mass-produced, body component.

The object presented above is also achieved by a body component having an opening in which a hole closure element of the type disclosed above is located. The advantages mentioned apply accordingly.

In principle, the surface region not covered by the adhesive may substantially correspond to the shape and size of the opening to be closed. This achieves a form closure of the body component and its associated hole closure element when in the inserted state. However, this type of fastening requires a very precise insertion of the adhesive-free surface region of the carrier element, which is not necessarily required for every application of a closure of an opening located in a body component. It may thus be provided, according to a preferred embodiment, that the surface region not covered by the adhesive is at a distance from the edge of the opening. This results in a gap between the opening and the adhesive-free portion located therein, which, however, is reliably covered by the overlapping part of the carrier element provided with adhesive.

According to a further preferred embodiment, it is provided that the opening has a third surface magnitude A3, and the surface region covered by the adhesive has a second surface magnitude A2, wherein the following relationship applies between the third surface magnitude A3 and the second surface magnitude A2:

$$1 / 4 \cdot A 2 \leq A 3 \leq 1 / 3 \cdot A 2$$

In other words, the surface magnitude of the part of the hole closure element according to the invention that is covered by the adhesive is substantially two to three times as great as the surface of the opening. This advantageously provides such a large overlap between the adhesive region with the bodywork component that it not only fastens the hole closure element securely, but also seals the opening against fluids such as, for example, water or air, and against sound. This applies in particular in the case if the adhesive-free part is not centered in the opening, but is positioned in an offset with respect to it.

A hole closure element of the type disclosed above may be produced in the following manner, or by execution of the following steps:
1. providing a carrier element spanning a virtual plane;
2. applying a region protruding from the carrier element and made of the same or a different material;
3. applying an adhesive to the carrier element;
4. covering the carrier element, provided with the adhesive, and the adhesive-free offset with a protective layer; and optionally
5. cutting to size the carrier element, provided with the protective layer, and the offset.

Alternatively, a hole closure element according to the invention may be produced in the following manner, or by execution of the following steps:
1. providing a carrier element spanning a virtual plane;
2. forming the carrier element at at least one discrete location in such a way that it has a region protruding therefrom;
3. applying an adhesive to the carrier element outside of the protruding region;
4. covering the carrier element, provided with the adhesive, and the adhesive-free region with a protective layer; and optionally
5. cutting to size the carrier element, provided with the protective layer, and the protruding region.

As a further alternative, a hole closure element according to the invention may be produced in the following manner, or by execution of the following steps:
1. providing a carrier element spanning a virtual plane;
2. applying a prefabricated adhesive means provided with adhesive-free recesses at discrete locations and/or an adhesive means in such a way that adhesive-free recesses are created on the carrier element when the adhesive means is applied;
3. embossing the carrier element in such a way that individual portions thereof extend, as protruding regions, through the recesses in the adhesive means; and optionally
4. cutting to size the carrier element, provided with the protective layer, and the protruding region.

Depending on the materials chosen, the respectively disclosed methods disclosed may provide for application of a protective layer, or may omit its application.

The following is a detailed, non-prejudicial, in particular non-restrictive, description of exemplary embodiments of the present invention, with reference to the appended figures, which are not to scale.

### BRIEF DESCRIPTION OF THE DRAWINGS

FIG. 1A is a simplified lateral sectional view of a hole closure element according to the invention, in a first embodiment.

FIG. 1B is a simplified lateral sectional view of a hole closure element according to the invention, in a second embodiment.

FIG. 2 is a simplified lateral sectional view of a hole closure element according to the invention.

FIG. 3B is a simplified lateral view of the hole closure element shown in FIG. 3A, without a protective film.

FIGS. 4A to 4C each show further embodiments of the closure element represented in FIG. 2.

FIGS. 5A to 5F each show different embodiments of hole closure elements in plan view.

FIGS. 6A and 6B each show further different embodiments of hole closure elements in plan view.

FIGS. 7A and 7b each show further different embodiments of hole closure elements in plan view.

FIG. 8 is a partially sectional view of a hole closure element according to FIG. 2 and FIG. 5A, fastened to a body component.

### DETAILED DESCRIPTION OF THE DRAWINGS

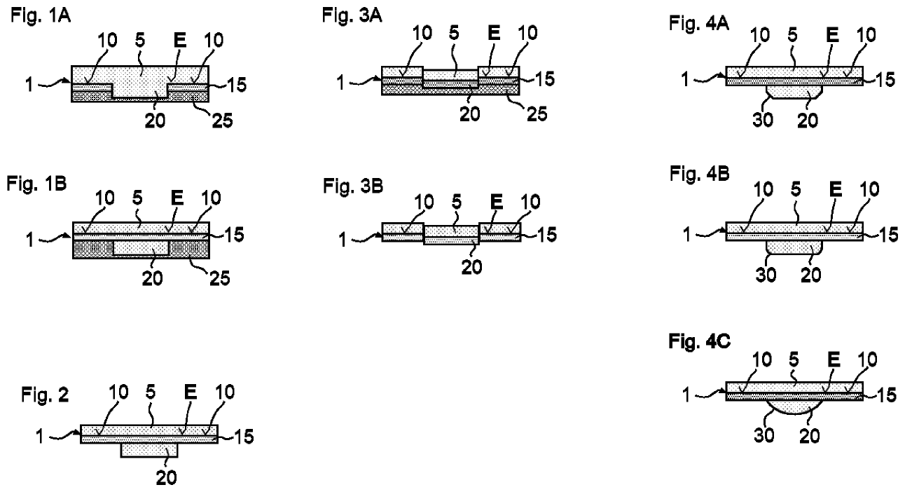

FIG. 1 shows a simplified lateral sectional view of a hole closure element 1 according to the invention. The hole closure element 1 has a carrier element 5 realized as a film material composed of PET. On what is its upper side in FIG. 1A, the carrier element 5 is substantially flat. On the side opposite to this side there is a first surface region 10 substantially realized as a virtual plane E, which according to the present exemplary embodiment is substantially parallel to the upper side of the carrier element 5. Applied to the surface region 10 there is an adhesive 15 that does not require thermal activation and that, according to this exemplary embodiment, is composed of an acrylate adhesive. The adhesive 15 thus covers the surface region 10. In addition, the carrier element 5 has a second surface region 20 which is different from the first surface region 10 and which protrudes from the carrier element 5 relative to the virtual plane E and serves to be received in an opening of a body component, not shown here, as will be described with reference to FIG. 8. According to this exemplary embodiment, the surface region 20 is designed as a thickening of material, such that the carrier element 5 has more material at this point than at the point where the adhesive 15 is located, i.e., than in the first surface region 10. According to this exemplary embodiment, the side of the surface region 20 that is distal from the upper side of the carrier element 5 is flat and substantially parallel to the plane E. Unlike the first surface region 10, the second surface region 20 is adhesive-free.

According to the exemplary embodiment shown here, the two surface regions 10, 20 are provided with a protective layer 25 to prevent damage to the side provided with the adhesive 15 and unintentional, unwanted adhesion of the hole closure element 1 to another item, not shown here. On the other hand, should it be desired to fasten the hole closure element 1 to a body component, not shown here, the protective film 25 is removed to expose the first surface region 10 and the second surface region 25. It is to be noted that a protective film 25 need not necessarily be provided. In particular, it is dispensable if there are a number of hole closure elements 1 provided for removal on a roll, not shown here, these being positioned in a manner known per se, overlapping and covering one another.

An alternative embodiment of a hole closure element 1 according to the invention, as compared to the embodiment shown in FIG. 1A, will now be described with reference to FIG. 1B. For reasons of clarity, only the differences between the embodiment shown in FIG. 1B and that shown in FIG. 1A will be discussed: while the surface region 20 not covered by the adhesive 15 that is represented in FIG. 1A was designed as a doubling of material, the surface region 20 of the exemplary embodiment not covered by the adhesive 15 that is shown in FIG. 1B is realized as an additional element, which is fastened to the carrier element 5 by means of the adhesive 15. In other respects, that which was stated in relation to FIG. 1A applies.

FIG. 2 shows a side view of a hole closure element 1 according to the invention, and without a protective layer 25. This may be designed realized to the exemplary embodiment shown in FIG. 1A or according to the exemplary embodiment shown in FIG. 1B.

FIG. 3A shows an alternative embodiment of a hole closure element 1 according to the invention, as compared to the embodiments shown in FIGS. 1A to 2, in simplified sectional view. In the exemplary embodiment shown in FIG. 3A, the surface region 20 not covered by the adhesive 15 is realized as a protrusion of the film material forming the carrier element 5 and is designed to be received in an opening of a body component, not shown here. Thus, the carrier element 5 has substantially the same thickness of material across its first surface region 10, which is provided with adhesive, and its second, adhesive-free surface region 20 and, unlike the exemplary embodiments previously represented, has no thickening of material. The hole closure element 1 shown in FIG. 3A also has a protective layer 25.

The hole closure means 1 represented in FIG. 3A is again shown in FIG. 3B in lateral view, and without a protective layer 25. As can be seen, the protruding part forms a comparatively sharp-edged offset. However, this is not absolutely necessary. Rather, although not shown here, a smooth transition may be provided between the first surface region 10 provided with adhesive and the second, adhesive-free surface region 20.

As can be seen from FIGS. 2 and 3B, the surface region 20 not covered by the adhesive 15 has, at its end that is most distant from the adhesive 15, what in section is a rectangular shape with a comparatively sharp offset. However, this is not absolutely necessary, as can be seen from FIGS. 4A, 4B and 4C: here, the respective surface region 20 not covered by the adhesive 15 has, at its end most distant from the adhesive 15, a peripheral taper 30, which may be in the form of a chamfer known per se (FIG. 4A) or as a rounding (FIG. 4B). In addition, the peripheral taper 30 may be lenticular, as shown in FIG. 4C.

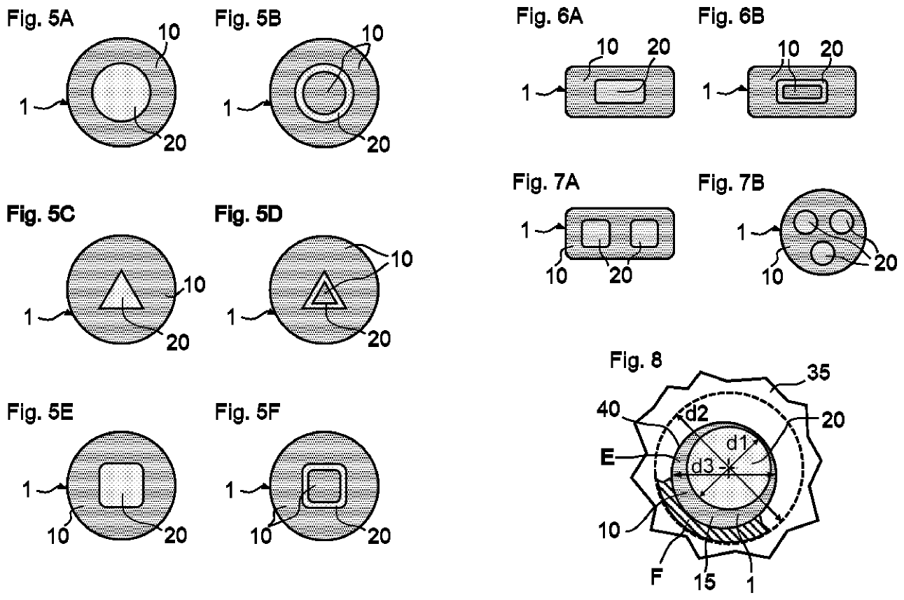

FIGS. 5A to 5F show different embodiments of hole closure elements 1 according to the invention, in plan view:

Thus, the hole closure element 1 shown in FIG. 5A corresponds to the hole closure element 1 represented in FIG. 2. As can be seen, the hole closure element is circular in shape, i.e., both the first surface region 10 provided with adhesive and the second, adhesive-free surface region 20 have a circular cross-section, the second surface region 20 being realized as a full surface. However, this is not absolutely necessary, as can be seen from FIG. 5B, since the second surface region 20 shown there is realized as a circular ring.

It can be seen from FIG. 5C that the second, adhesive-free surface region 20 does not necessarily have to be realized as a circle or circular ring, even if the first surface region 10 provided with adhesive has a circular cross-section. Rather, the second surface region 20 is designed in the form of a triangle, the geometric centroid of which coincides with the geometric centroid of the first surface region 10. The second, adhesive-free surface region 20 represented in FIG. 5C is in the form of a full-surface triangle. However, this is not necessarily the case, as can be seen in FIG. 5D. There, the second surface region 20 is realized by a triangular wall.

Finally, it can be seen from FIG. 5E that the second, adhesive-free surface region 20 does not necessarily have to be realized as a circle, circular ring, triangle or triangular wall, even if the first surface region 10 provided with adhesive has a circular cross-section. Rather, the second surface region 20 depicted in FIG. 5E is designed in the form of a quadrilateral with rounded corners, the geometric centroid of which coincides with the geometric centroid of the first surface region 10. The second surface region 20 represented in FIG. 5E is designed as a full-surface quadrilateral. However, this is not necessarily the case, as can be seen in FIG. 5E. There, the second, adhesive-free surface region 20 is realized by a quadrilateral wall with rounded corners.

The first, adhesive-containing surface regions 10 previously represented each had a circular cross-section in plan view. However, this need not necessarily be the case, as can be seen from FIGS. 6A and 6B:

The first surface region 10 provided with adhesive shown in FIG. 6A is realized as a rectangle formed with rounded corners, located in the geometric centroid of which is the second rectangular, adhesive-free surface region 20, also having rounded corners. This adhesive-free second surface region 20 is realized over the entire surface. However, this is not necessarily the case, as can be seen in FIG. 6B. There, the second surface region 20 is realized by a rectangular wall.

The hole closure elements 1 represented thus far each have a single second, adhesive-free surface region 20. However, this is not absolutely necessary, as can be seen from FIGS. 7A and 7B. Rather, a plurality second, adhesive-free surface regions 20 may also be provided on the hole closure element 1. For example, in the case of the hole closure element 1 represented in FIG. 7A, two adhesive-free surface regions 20 are provided on a first surface region 10 provided with adhesive, which is rectangular with rounded edges. The two surface regions 20 provided with adhesive are each realized as squares with rounded edges. In FIG. 7B, by contrast, the first adhesive-containing surface region 10 is circular. In addition, the hole closure element 1 has three equally spaced, likewise circular, second adhesive-free surface regions 20 of equal diameter, which are at a distance from the outer edge of the hole closure element 1.

It is understood that the first containing surface regions 10 provided with adhesive represented in FIGS. 1A to 7B may also have other shapes, or geometries. Thus, it is possible for them to be realized as triangles, quadrilaterals, polygons, ellipses or the like, although this is not shown here.

It is further understood that the second, adhesive-free surface regions 20 represented in FIGS. 1A to 7B may also be present in other numbers and in other shapes, or geometries. Thus, more than three second surface regions 20 may also be provided, and/or these may be realized with walls rather than with full surfaces.

Finally, it is understood that a combination of the possibilities presented in the two preceding paragraphs may also be provided.

The hole closure element 1 represented in FIG. 2 and in FIG. 5A is bonded to a body component 35 in order to close an opening 40 therein. Such an installation position of the hole closure element 1 is shown in FIG. 8. In the view selected in FIG. 8, the virtual plane E is beyond the plane of the paper, while the second surface region 20, which is not covered by the adhesive 15, extends out of the plane of the paper, toward the viewer of FIG. 8. As can be seen, the second surface region 20 is located eccentrically in the opening 40. However, it is understood that a substantially central arrangement of the second surface region 20 in the opening 40 may also be provided.

As shown by FIG. 8, the adhesive-free surface region 20 has a diameter d1, from which, due to its circular shape, a first surface magnitude A1 can be directly calculated. The surface region 10 provided with adhesive has a diameter d2, from which, due to its circular shape, a second surface magnitude A2 can be directly calculated. Finally, the circular opening 40 has a third diameter d3, from which a third surface magnitude A3 can be directly calculated. The surface magnitudes A1, A2 and A3 are configured in such a way that, despite the eccentric arrangement of the adhesive-free surface region 20, there is a sufficiently large overlap region between the surface region 10 provided with the adhesive 15 and the material of the body component 35 surrounding the opening 40, as indicated by the portion F shown in FIG. 8, which represents only part of the overlap region. This enables the hole closure element 1 to be arranged on the body component 35 in a reliably secure and sealing manner.

### LIST OF REFERENCE CHARACTERS

1 hole closure element
5 carrier element
10 first surface region
15 adhesive
20 second surface region
25 protective layer
30 peripheral taper
35 body component
40 opening
A1 first surface region
A2 second surface region
A3 first surface region
E virtual plane
F overlap region
d1 first diameter
d2 second diameter
d3 third diameter

1.-10. (canceled)

11. A hole closure element for an opening located in a body component, comprising:
a carrier element made of a film material; and
an adhesive located on one side of the carrier element;
wherein the adhesive does not require thermal activation and covers a first surface region of the carrier element, wherein the adhesive does not cover a second surface region of the carrier element, and wherein the second surface region not covered by the adhesive protrudes from a virtual plane formed by the carrier element and is configured to be received by the opening.

12. The hole closure element according to claim 11, wherein the second surface region not covered by the adhesive is formed by a thickening of the film material.

13. The hole closure element according to claim 11, wherein the second surface region not covered by the adhesive is formed by a protrusion of the film material.

14. The hole closure element according to claim 11, wherein the second surface region not covered by the adhesive has a peripheral taper at an end that is most distant from the adhesive.

15. The hole closure element according to claim 11, wherein the second surface region not covered by the adhesive is located in a center of the hole closure element and wherein the first surface region covered by the adhesive is located outside of the center of the hole closure element.

16. The hole closure element according to claim 11, wherein the second surface region not covered by the adhesive has a first surface magnitude (A1), wherein the first surface region covered by the adhesive has a second surface magnitude (A2), and wherein a relationship applies between the first surface magnitude (A1) and the second surface magnitude (A2) that is:
$$1 / 4 \cdot A 2 \leq A 1 \leq 1 / 3 \cdot A 2$$

17. The hole closure element according to claim 11, wherein the adhesive is a pressure-sensitive adhesive.

18. An apparatus, comprising:
a body component with an opening; and
the hole closure element according to claim 11 disposed in the opening.

19. The apparatus according to claim 18, wherein the second surface region not covered by the adhesive is at a distance from an edge of the opening.

20. The apparatus according to claim 18, wherein the second surface region not covered by the adhesive has a first surface magnitude (A1), wherein the first surface region covered by the adhesive has a second surface magnitude (A2), wherein the opening has a third surface magnitude (A3), and wherein a relationship applies between the third surface magnitude (A3) and the second surface magnitude (A2) that is:
$$1 / 4 \cdot A 2 \leq A 3 \leq 1 / 3 \cdot A 2$$
